(19) United States
(12) Patent Application Publication
(10) Pub. No.: US 2016/0239921 A1
(43) Pub. Date: Aug. 18, 2016

(54) APPARATUS AND METHODS FOR ESTIMATING AN EXTENT OF PROPERTY DAMAGE

(71) Applicant: AutoClaims Direct Inc., Carlsbad, CA (US)

(72) Inventors: Ernest B. Bray, Escondido, CA (US); Brian Bray, San Diego, CA (US)

(21) Appl. No.: 14/623,440

(22) Filed: Feb. 16, 2015

(51) Int. Cl. G06Q 40/08

(52) U.S. Cl. CPC G06Q 40/08

(57) ABSTRACT

Apparatus and methods for estimating the amount of damage to an item. In one embodiment, the apparatus comprises a server entity adapted to receive information from a plurality of sensor devices disposed on internal and/or external surfaces of an item. The server entity processes the information received from the sensor devices after a damage event occurs and determines an estimate of the damage to the item and each of the individual parts that were damaged. The server delivers the estimate to an insurance entity for approval and/or to a client device along with a list of repair entities. In addition, the sensor devices are able to provide continuous information with respect to the current state of an item, including when no significant damage event has occurred. Exemplary methods for accomplishing the above are also given.

### BACKGROUND

1. Technological Field

The disclosure relates to estimating damage to property, insurance claims processing, and repairs. In one exemplary aspect, the disclosure relates to estimating an extent of property damage to vehicles such as automobiles, semi-trailer or truck, boats and other water-craft, all-terrain vehicles, airplanes, busses and other mass transit vehicles, trains, motorcycles, and sports vehicles, then processing an insurance claim for the damage, and determining a repair solution. Damage to other property may also be estimated such as homes, mobile homes, and other items of chattel.

2. Description of Related Technology

For many repair facilities, insurance companies, and damage appraisers, it is necessary to obtain an appraisal of the extent of the property damage. For example, the extent of damage to an automobile which has been involved in a collision. It is particularly important to determine the estimate of damage efficiently and accurately, including the time and/or cost for repairing the damage and in some instances whether the cost to repair the damage is greater than the estimated value of the property.

With respect to vehicles in particular, in some instances, vehicle inspection stations use cameras to capture images of the automobile, for detecting whether the automobile has been damaged. The vehicle inspection stations compare at least a portion of the image with a previously stored image of the automobile. However, the vehicle inspection stations are not configured to assess the damage, provide an estimate for the repair of the damage, and/or capture and assess damage to internal parts of the automobile.

In addition, a computerized insurance estimating system may be used by insurance companies and repair facilities to obtain information about parts, labor, and repair operations for automobile repairs. These systems utilize an application program which displays various sections of the outer layer of the automobile including body parts of the automobile, such as the rear bumper, doors, rear and front fenders, and the hood of the automobile. By clicking on provided selection circles, the insurance companies and repair facilities select one or more damaged automobile parts. An estimate is then determined based on the selected automobile parts including the purchase price of the part and the cost of labor involved in replacing the part. However, such systems are not configured to determine in more detail the damage to individual parts of the automobile.

Accordingly, despite the foregoing systems and methods, there is still a salient need for more efficient and reliable techniques and apparatus for the estimating the amount or extent of property damage. Such improved techniques and apparatus would ideally provide at least the most germane information for determining the amount of damage to property, allow for more accurate estimates for the cost to repair the property, provide continuous data regarding the current status of the property and each of the parts thereof, as well as speed up the insurance claim process. Ideally the improved techniques and apparatus would also be compatible with current personal electronics and networking technologies.

### SUMMARY

The present disclosure addresses the foregoing needs by providing, in various embodiments, methods and apparatus for estimating an extent of property damage, providing efficient insurance claims processing, and determining whether repairs are warranted via information compiled from a plurality of sensor devices located on the damaged property.

In a first aspect, an apparatus configured to estimate an extent of damage to at least one item. In one embodiment, the apparatus includes a first interface in communication with a plurality of sensor devices located on the at least one item; a storage apparatus; and a processor in communication with the storage apparatus and configured to execute at least one computer program thereon, the computer program comprising a plurality of instructions which are configured to when executed by the processor cause the apparatus to: (i) receive via the first interface a plurality of information from at least one of the plurality of sensor devices, the plurality of information comprising data relating to a current status of the at least one of the plurality of sensor devices; and (ii) evaluate the data relating to the current status of the at least one of the plurality of sensor devices to determine an estimate of damage of the at least one item.

In a second aspect, a method for estimating an extent of damage to at least one item is disclosed. In one embodiment, the method includes receiving a plurality of information from one or more sensor devices located on one or more surfaces of the at least one item, the plurality of information comprising data relating to a damage event; comparing the plurality of information to item specification information for determining a level of variance therefrom; and determining a repair estimate based at least in part on the level of variance.

In a third aspect, a computer readable apparatus comprising a storage medium, the storage medium comprising at least one computer program is disclosed. In one embodiment, the computer program comprises a plurality of instructions configured to, when executed by a processing apparatus, receive a plurality of information from at least one of a plurality of sensor devices, the plurality of information comprising data relating to a current status of at least one of the plurality of sensor devices; and assess the plurality of information data relating to the current status of the at least one of the plurality of sensor devices to determine an estimate of damage of the at least one item.

In a fourth aspect, a system for estimating an extent of damage to at least one item is disclosed.

In a fifth aspect, a consumer premises device (CPE) for estimating an extent of damage to at least one item is disclosed.

These and other aspects of the disclosure shall become apparent when considered in light of the detailed description provided herein.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a functional block diagram illustrating an exemplary estimatics server according to the present disclosure.

FIG. 2 is a logical flow diagram illustrating an exemplary method of employing the estimatics server of FIG. 1 to efficiently estimate property damage and transmit information regarding the damage to one or more second entities according to the present disclosure.

FIG. 3 is a logical flow diagram illustrating an exemplary method of employing the estimatics server of FIG. 1 to efficiently estimate property damage and to efficiently provide a list of repair entities to a user according to the present disclosure.

FIG. 4 is a logical flow illustrating an exemplary method of utilizing the estimatics server of FIG. 1 to efficiently generate a property insurance damage estimate according to the present disclosure.

FIG. 5 is a logical flow diagram illustrating an exemplary method of employing the estimatics server of FIG. 1 to efficiently estimate property damage, contact emergency personal, and to efficiently provide a list of repair entities to a user according to the present disclosure.

FIG. 6 is a logical flow diagram illustrating an exemplary method of employing the estimatics server of FIG. 1 to continuously monitor a plurality of items and efficiently estimate the damage to one or more of the plurality of items according to the present disclosure.

All figures are © Copyright 2015 Auto Claims Direct, Inc. All rights reserved.

### DESCRIPTION OF THE DISCLOSURE

Reference is now made to the drawings listed above, wherein like numerals refer to like parts throughout.

As used herein, the term “application” refers generally to a unit of executable software that implements theme-based functionality The themes of applications vary broadly across any number of disciplines and functions (such as e-commerce transactions, shipping transactions, entertainment, calculator, Internet access, etc.), and one application may have more than one theme. The unit of executable software generally runs in a predetermined environment; for example and without limitation, the unit could comprise a downloadable Java Xlet™ that runs within the JavaTV™ environment.

As used herein, the terms “client device,” “terminal,” “personal electronic device” (PED) and “user device” include, but are not limited to, personal computers (PCs), whether desktop, laptop, or otherwise, personal digital assistants (PDAs) such as the “Palm®” family of devices, cellular or “smart” phones such as the Apple iPhone handheld computers, J2ME equipped devices, personal media devices, set-top boxes, or literally any other device capable of interchanging data with a network. Such devices may interface using wired or optical fiber mechanisms such as an IEEE Std. 802.3 Ethernet interface, Digital Subscriber Line (DSL), DOCSIS modem, hybrid fiber-coax (HFC) cable, FireWire (IEEE Std. 1394), or alternatively via wireless mechanisms and protocols such as 3GPP/3GPP2, Bluetooth™, IrDA interface, IEEE Std. 802.11, UWB (e.g., IEEE-Std. 802.15 or similar), WiMAX (802.16), Wireless Application Protocol (WAP), GPRS, GSM, or any other of myriad data communication systems and protocols well known to those of skill in the communications arts.

As used herein, the term “computer program” is meant to include any sequence of human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “database” refers generally to one or more tangible or virtual data storage locations, which may or may not be physically co-located with each other or other system components.

As used herein, the term “digital processor” is meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “display” means any type of device adapted to display information, including without limitation CRTs, LCDs, TFTs, plasma displays, LEDs, and fluorescent devices.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), and PSRAM.

As used herein, the term “network” refers generally to data or communications networks regardless of type, including without limitation, LANs, WANs, intranets, internets, the Internet, cable systems, telecommunications networks, satellite networks, and Virtual Private Networks (VPNs), or collections or combinations thereof, whether based on wired, wireless, or matter wave modalities. Such networks may utilize literally any physical architectures and topologies (e.g. ATM, IEEE-802.3, X.25, Token Ring, SONET, 3G/3GPP/UMTS, 802.11, 802.16, 802.15, Hybrid fiber-coax (HFC), etc.) and protocols (e.g., TCP/IP, HTTP, FTP, WAP, GPRS, RTP/RTCP, etc.).

As used herein, the term “vehicle” refers to any form of air, land or water transportation for either person, animals, and/or inanimate objects including, without limitation, buses, cars, sports utility vehicles, semi-trucks/trailers, mobile homes, recreational vehicles, all terrain vehicles, motorcycles, boats and other water craft, etc.

### Overview

The present disclosure provides, inter cilia, methods and apparatus for estimating property damage, and for determining appropriate repairs via information compiled from a plurality of sensor devices located on the property.

The present disclosure provides, inter alia, methods and apparatus for estimating an extent of damage to at least one item. In one embodiment, an apparatus receives a plurality of information relating to a current status of the at least one item. The plurality of information is collected by a plurality of sensor devices located on one or more surfaces of the at least one item. The plurality of information includes information such as the size of the area damaged, the specific areas damaged, the degree of deformation to the item, etc. In one exemplary embodiment, the sensor devices are multifunctional micro-sensors which cover substantially the entirety of the at least one item. The apparatus then evaluates the plurality of information relating to the current status of the at least one item to determine an estimate of damage.

In another embodiment, the apparatus is further configured to transmit a list of repair entities to one or more client devices. In one variant, prior to transmitting the list of repair entities to the one or more client devices, the apparatus transmits the estimate of damage to an insurance entity associated with a user of the item, seeking approval from the insurance entity regarding the estimate of damage. When the insurance entity does not approve the estimate of damage, the insurance entity provides an insurance estimate of damage to the apparatus. In another variant, the apparatus transmits the estimate of damage and/or the insurance estimate of damage to the user along with the list of repair entities. The apparatus then receives a selection of a repair entity from the user via a client device. Upon receipt of the selection the apparatus transmits the estimate of damage to the selected repair entity. In one variant, the apparatus transmits the plurality of information to the repair entity as well and transmits the selection of the repair entity to the insurance entity associated with the user of the item.

Additionally, the aforementioned sensors disposed on an item may be utilized to constantly monitor the current state of the item. Information reporting the current state may be provided (via push or pull mechanisms) periodically, and/or only upon detection of a damage event. In this manner, the item owner can receive information relating to the damage of an item over time as well as upon the occurrence of a damage event.

Methods of operating the network(s), client devices, and for doing business using the network referenced above, are also described.

### Description of Exemplary Embodiments

It is noted that while the system and methods of the disclosure described herein are discussed with respect to determining an estimate of the damage to a vehicle or home, certain aspects of the disclosure may be useful in other applications, including, without limitation, other types of property or chattel (including e.g., electronics, commercial buildings, apartment complexes, or other such items) and/or undamaged items.

### Estimatics System—

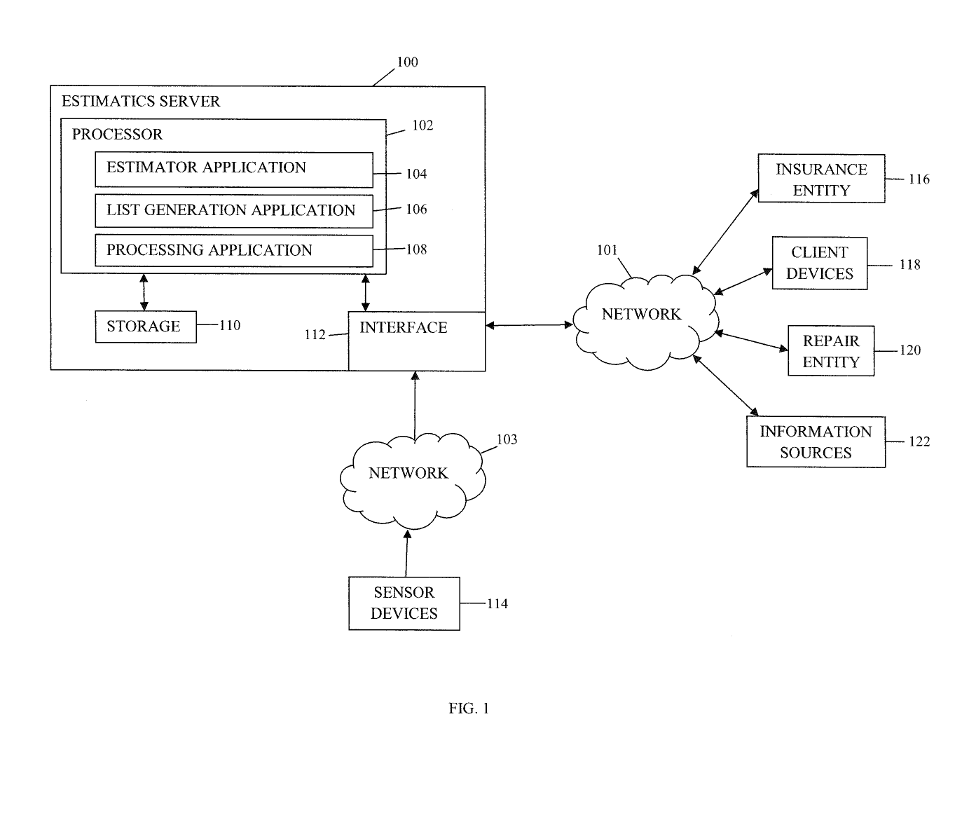

One salient feature of the present disclosure is the utilization of one or more estimatics servers. An exemplary estimatics server 100 is illustrated in FIG. 1. As shown, the estimatics server 100 generally comprises a digital processor 102, a storage device 110 and at least one interface 112 for communication to other devices via one or more networks 101 and 103. Although illustrated as a single device, it is appreciated that the estimatics server 100 may comprise any number of distinct devices and form factors and/or several servers 100 may be utilized in coordination.

In the illustrated embodiment, the interface 112 of the estimatics server 100 is the subsystem for data transfer into and out of the estimatics server 100. For example, data regarding damaged property (e.g., size of the area damaged, the specific areas damaged, the degree of deformation to the damaged item, etc.) may be transferred into the estimatics server 100 from one or more sensor devices 114 located on the item or property.

In one exemplary embodiment, the sensor devices 114 are multifunctional micro-sensors which cover substantially the entirety of the item, and which communicate a severity or extent of the damage to each part of the item. The item may comprise a vehicle, such as an automobile, a semi-truck/trailer, a motorcycle, a bus, a train, an airplane, a boat, or other water craft, etc. In another embodiment, the item may comprise a building, such as a home, apartment, office building, mobile home, etc. and cover such parts of the building as the exterior walls, windows, the roof etc. In yet another embodiment, the item may comprise any form of chattel including but not limited to a computer, household items such as kitchen appliances, heaters, air conditioners, etc. The sensor devices 114 are disposed on the property via either a painted-on procedure or a web-like application (as discussed in greater detail elsewhere herein).

In one specific example, assuming the item in question was a vehicle and was impacted to the right front area, the sensor devices 114 transmit information regarding the impact to the estimatics server 100 automatically. The information may include the degree of damage to each piece of the vehicle that was damaged, such as the bumper lamp assembly, suspensions parts, frame, fender, and/or structural and sheet metal portions. In one variant, the sensor devices 114 also transmit data regarding the parts of the vehicle that were not damaged, so as to provide a full or complete report detailing information from every sensor. According to this variant, damage which may not be immediately visible to the naked eye. The damage description information may alternatively identify only those portions of the vehicle that remain useable. Furthermore, the sensor devices 114 can measure the airflow, global position system (GPS) positioning, acceleration, temperature, gyroscope readings, strain and magnetic field strength in order to report still further data regarding an incident resulting in damage to the property. In addition, the sensor devices 114 may be utilized to sense and report other types of item incidents, for example, in the instance that the item is a vehicle, the sensor devices 114 may sense loss of four-wheel contact with the ground, bodily rotation, and/or inversion.

In another example (not illustrated), information about the extent of damage to an item is transferred into the estimatics server 100 from a client device 118 in direct communication with the sensors 114. In this example, after the data from the sensor devices 114 is generated, it is transmitted to the estimatics server 100 from the client device 118 via the network 101, either through a push or pull mechanism. The push/pull may occur periodically, or may be triggered by a damage-inducing event.

Additional information regarding the property may also be provided to the estimatics server 100. The additional information may include e.g., name of the user, vehicle specific information (such as vehicle identification number (VIN) or other identifier, vehicle descriptive information (such as make, model, year, etc.) and/or damage description information (including photos and/or videos demonstrating the extent of the damage). In one variant, this information is inputted by a user of the client device 118. Alternatively, it may be gathered from the sensors 114 (that is the sensors 114 provide the information about the property identity in addition to property damage information). In a further example, the information about the property identity may be provided during system initiation.

Further information about the damaged item may be transferred into the estimatics server 100 from one or more information sources 122. Exemplary information sources 122 include, inter alia, estimated resale servers, estimated wholesale servers, vehicle history report servers and/or item part servers. Information received from the information sources 122 may be based on the aforementioned additional property information received from the client device 118, the sensors 114, or provided at system setup. For example, the estimatics server 100, prior to receiving data from the one or more information sources 122, may send a request to the client device 118 to confirm and/or obtain identifying item information, such as a VIN. The estimatics server 100 upon receipt and/or confirmation transmits the identifying item information to the information sources 122. The one or more information sources 122 based on the identifying item information then generate a report or transmit raw data to the estimatics server 100. The estimatics server 100 in either variant uses the information received from the client device 118 and/or the one or more information sources 122 to determine an estimate of repair for the damaged item as will be described in further detail below.

Referring again to FIG. 1, the estimatics server 100 further comprises a digital processor 102, which, in one embodiment, is configured to run one or more computer programs (stored at the storage apparatus 110), the computer programs are configured to cause the estimatics server 100 to obtain information from the sensors 114, the client device 118, and/or the one or more information sources 122 (such as via generation of an interactive interface or graphic user interface). Additionally, the one or more computer programs may enable the estimatics server 100 to generate requests to the various one or more information sources 122, and enable the estimatics server 100 to format data received from sensors 114, the one or more information sources 122, and/or client device 188 into data which is more efficiently useable.

In another embodiment, the processor 102 is configured to at least an estimator application 104, a list generation application 106, and a processing application 108 thereon. In another variant, the estimator application 104, the list generation application 106, and/or the processing application 108 may comprise one or more applications and/or may reside on one or more separate servers, in communication with the estimatics server 100.

The estimator application 104 comprises a computer program that enables the estimatics server 100 to determine an estimate or extent of the property damage. In one variant, the estimate of the damage may comprise a monetary estimate report for repairs to the damaged item. The monetary estimate of the damage takes into account labor rate prices based on the geographical location of the item and/or tax rates for the geographical location as well as costs for replacement parts. In one embodiment, the estimator application 104 is configured to compute the estimate using an algorithm which utilizes information received from the one or more information sources 122, the client device 118, and/or information received from the sensor devices 114 to determine an estimate for the damaged item. The information received from the one or more information sources 122 may include e.g., property or vehicle history reports, estimated resale value, and/or historical damage analysis of trained physical damage estimators. In addition, the information received from the client device 118 may include e.g., name of the user, property or vehicle specific information (such as vehicle identification number (VIN) or other identifier, property or vehicle descriptive information (such as make, model, year, etc.) and/or damage description information (including photos and/or videos demonstrating the damage). The information received from the sensor devices 114 may include raw data relating to damaged and/or undamaged portions of the item. Additionally, the estimator application 104 may be configured to request additional information from the one or more information sources 122, the sensors 114, and/or the client device 118. Once the information is compiled into an appropriate record or report, the estimator application 104 transmits it as an estimate of the damage to an insurance entity 116, the client device 118, and/or a repair entity 120 via the network 101. In addition, the estimate of the damage may also include a range of valid repair estimates consistent with the information transmitted from the sensor devices 114 and/or other information transmitted from the client device 118 and/or the one or more information sources 122.

In another embodiment, the estimator application 104 determines the estimate of damage in the form of a database look-up, in which the input comprises the information transmitted from the sensor devices 114 and/or additional information obtained from the client device 118 and/or one or more information sources 122 and the output is the estimate of the damage to the item. In other words, the estimatics server 100 has stored thereon a database which comprises one or more tables in which information received from the sensors 114, client device 118, and other information sources 122 is entered (via the estimator application 104) and an approximation of the cost for repairs is determined and outputted. The database may be pre-generated and stored at the server 100 or other entity in communication therewith and updated periodically. Alternatively, the database may be dynamic in nature such that it is able to “learn” based on feedback received regarding actual costs to repair. That is, the database may be configured to use actual values of repairs to more accurately predict or generate estimates.

In another embodiment, the estimate of the damage may be made searchable. According to this embodiment, the insurance entity 116, the client device 118 and/or the repair entity 120 may query the estimatics server 100 to obtain additional copies of the estimate of the damage or additional information regarding the particular item.

As indicated above, a list generation application 106 is also optionally run on the estimatics server 100. The list generation application 106 enables the estimatic server 100 to determine to which repair entities 120 the estimate of the damage will be transmitted. In one variant, the list generation application 106 is further configured to generate a list of repair entities within a given proximity to the damaged item. The list generation application 106 determines the proximity based on the data transmitted by the sensor devices 114, the other information sources 122, and/or the client device 118. Additionally, the list generation application 106 is configured to transmit the list of repair entities to the client device 118. In one embodiment, the list of repair facilities is first authorized by the insurance entity 116 to ensure that at least a portion of the repairs done at a selected one of the listed facilities will be covered under the owner's insurance policy. To accomplish this, a first list is provided to the insurance entities 116, which returns a revised list having only those authorized repair facilities listed.

As indicated above, a processing application 108 is also optionally run on the estimatics server 100. The processing application 108 is configured to process the raw data received from the sensor devices 114 into a format, which allows the estimator application 104 to compare the damaged parts of the item to certain criteria standards (per the estimator application 104). The comparison helps to determine the extent of the damage, whether the item is operational, and/or whether the damage is serious enough in nature to elicit the estimatics server 100 to contact emergency personal and/or a repair entity.

In another embodiment, the processing application 108 is further configured to process the information (i.e., raw data), format the information for storage and subsequent transmission, database building or updating, and searches. The processing and/or formatting may comprise parsing the received information so that it may be provided in a summarized format to the client devices 118, the repair entity 120 and/or the insurance entity 116. In other words, an initial presentation of information to the client devices 118, the repair entity 120 and/or the insurance entity 116 may comprise only portions of the entire information which give a very basic level of detail about the damage. The insurance entity 116 may enter further communications with the estimatics server 100 to obtain more detailed information, such as information specific to the particular item and/or an estimate of the total damage and repair.

In one variant, the computer programs are configured to cause the estimatics server 100 to transmit the estimate report with a list of repair entities to the client device 118 and/or the insurance entity 116. Other functions of the digital processor 104 and/or other computer program-implemented functionality will be discussed in detail below as well.

The storage device 110 of the estimatics server 100 is adapted to store the information received from the sensor devices 114, store processed and formatted information, store estimates of the damage, store lists of repair entities based on geographical locations and/or store lists of repair entities approved for each of the insurance entities 116. In one embodiment, the items may comprise vehicles and the estimates of the damage may be stored and sortable by vehicle VIN number. In another embodiment, the stored list of repair entities approved by a certain insurance entity may be provided to other users who have the same insurance entity.

It is also appreciated that the methods of the present disclosure may be practiced using any configuration or combination of hardware, firmware, or software, and may be disposed within one or any number of different physically or logically distinct entities. Myriad different configurations for practicing the disclosure will be recognized by those of ordinary skill in the art given the present disclosure.

The estimatics server 100 can also be masked or controlled by a “business rules engine” or other logical wrapper or layer as described subsequently herein.

### Exemplary Operation—

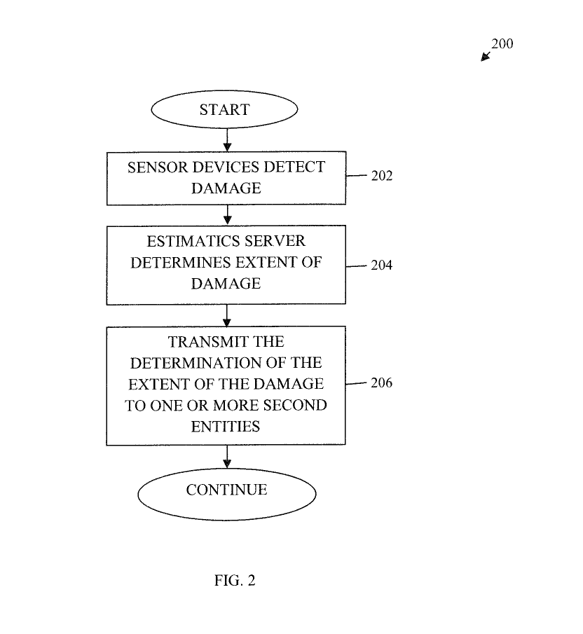

An exemplary method 200 of employing the estimatics server 100 of the present disclosure to efficiently estimate the damage to an item and transmit the determination to one or more second entities is now described with respect to FIG. 2. As illustrated, at step 202, the sensor devices 114 collect data regarding the item which has experienced a damage event. The information may include e.g., size of the area damaged, the specific areas damaged, the degree of deformation to the damaged item, etc. The sensor devices 114 send the data to the estimatics server 100.

In addition, at the occurrence of a damage event, an immediate determination as to the severity of the occurrence may trigger immediate alerts to be sent to local police and emergency services. This determination is based on an initial review of the raw data received from the sensors 114. The location of the item to which emergencies services are dispatched may be collected from the sensor data as well. Still further, based on an immediate detection of the level of severity, a tow truck or other non-emergency services may be provided.

Next per step 204, the estimatics server 100 determines the extent of the damage and generates an estimate for repair thereof. In one embodiment, the received data is processed and formatted into a format which allows the estimatics server 100 to compare the damaged parts to specific criteria (i.e., original equipment manufacturer (OEM) specifications) to determine the extent of the damage and the necessary repairs and/or replacements parts. In one variant, the estimatics server 100 in determining the extent of the damage transmits a request for additional information to the sensors 114, client device 118, and/or the information sources 122. The request may seek such information as, the item year, make, model, and/or other identifying information. The estimatics server 100 then determines the reparability of the parts from the data and generates an estimate. The estimate is based on such factors as current mileage, year, model, etc. of the item.

Next, per step 206, the estimate of the damage is transmitted to one or more second entities. In one embodiment, the one or more second entities comprise the insurance entity 116, the client device 118 and/or the repair entity 120. In one variant, the one or more second entities receive a list of the closest repair entities to the item damaged. A user of the client device 118 may select a repair entity from the list which may, in one variant, comprise a revised list having only pre-approved repair facilities listed. In this embodiment, the selected repair entity 120 receives the estimate, the pre-approval, and additional information regarding the damage for the particular item.

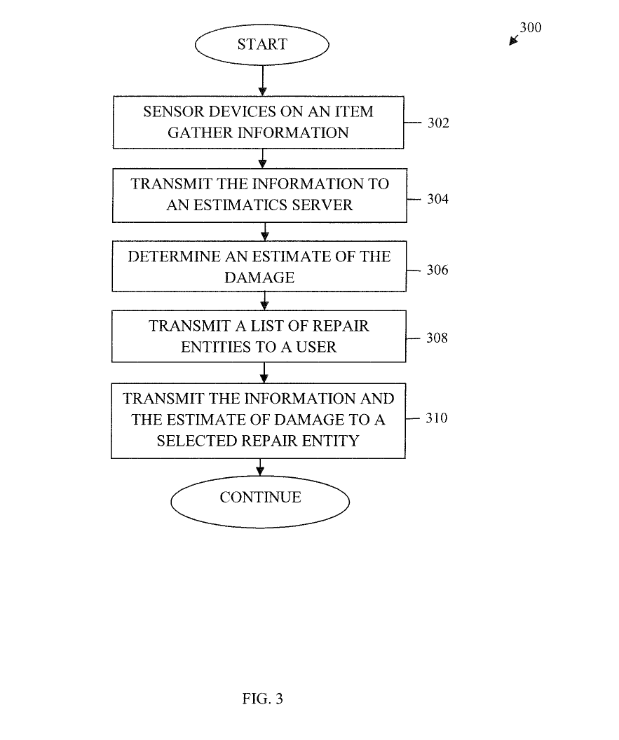

Referring now to FIG. 3, another exemplary embodiment of a method 300 of employing the estimatics server 100 of the present disclosure to efficiently estimate damage to an item and to efficiently provide a list of repair entities to a user is described. At step 302, the sensor devices 114 located on an item gather information after a damage event occurs.

The sensor devices 114 are attached on the exterior of the item by, in one embodiment, being painted thereon. Additional interior portions of the item (such as portions of the engine, interior walls, etc.) may also be painted with a sensor-containing coat. In another alternative, the sensors 114 may be applied to the item using a web like application. The web like application comprises a web of the sensor devices 114 which are embedded on a web or mesh like fabric and is applied or rolled out on the exterior of the item. Additionally interior portions of the item (such as portions of the engine, interior walls, etc.) may also have the sensor devices 114 applied using the web like application. In another variant, the sensor devices 114 are embedded on each part of the item. The sensors devices 114 gather information in real time regarding a level or severity of damage to every part in the item; this may range from zero damage to total loss. The sensor devices 114 may additionally record such information as speed of the item, distance between other location points of other sensor devices, distance within manufacture part tolerances, etc. For example, if a vehicle having these sensors 114 applied thereto was impacted to the right front, the sensor devices 114 would after the damage event, transmit information regarding which parts of the vehicle were damaged, such as a bumper, lamp assembly, and/or fender. The sensors 114 would also transmit data relating to the severity of damage such as the size and/or area of the damage, degree of deformation to the damaged part based on e.g., how far out of spec the measurements are as compared to the manufacturer tolerances. Per step 304, this information is transmitted to the estimatics server 100.

Next, per step 306, the estimatics server 100 determines an estimate of the damage to the item. In one embodiment, the estimatics server 100 determines the estimate based on the location of each of the sensor devices 114 on the item and a variance of the damage, which is compared to original equipment manufacture (OEM) specifications. In another variant, the resultant evaluation is then compared with information received from the one or more information sources 122. The estimatics server 100 may further use an algorithm to compare the received information to historical damage analysis performed by trained physical damage estimators in order to determine the repair estimate. In the estimate is, in one variant, provided to insurance providers 116 and/or the client device 118.

In another embodiment, the estimatics server 100 interprets and autonomously determines which parts of the item that need to be replaced and which parts are able to be repaired based on the severity and location of the damage from the information received from the sensor devices 114. In addition, the estimatics server 100 when determining the estimate takes into account the labor rate prices and the tax rates based on the geographic location of the item and/or the user. The estimatics server 100 is able to determine the geographical location based on the information received from the sensor devices 114. Alternatively, the estimatics server 100 determines the geographic location by sending a request to the client device 118 inquiring about the item and/or the user's location.

In another embodiment, the information transmitted to the estimatics server contains enough information to allow the estimatics server 100 to identify a user of the item. For example, upon receipt of the transmission, the estimatics server 100 develops, through an interactive database look-up, records identifying the user who owns the item and the type of item. A request may be transmitted to the client device 118 to confirm the user's identity under this model. When the estimatics server 100 cannot correctly identify the user, further information may be required from the client device 118 (such information as the name of the user and insurance company associated therewith, as well as item information such as year, make, model, identification number, other options, etc).

The confirmed identity of the user and item as well as damage information (either as an estimate or report, or as raw data received from the sensor devices 114) is provided to the insurance entity associated with the user.

In yet another embodiment, the apparatus and methods of co-owned, co-pending U.S. patent application Ser. No. 14/572,660 entitled “APPARATUS AND METHODS FOR MANAGING DELIVERY OF ITEM INFORMATION AND FACILITATING A SALE OF AN ITEM” filed on Dec. 16, 2014, which is incorporated herein by reference in its entirety, is utilized in conjunction with the present disclosure. As discussed therein, the estimatics server 100 may send a send a request to the salvage collection server seeking vehicle specific information (such as vehicle identification number (VIN or other identifier, vehicle descriptive information (such as make, model, year, etc.) and/or damage description information (including photos and/or videos demonstrating the extent of the damage). The provided information from the salvage collection server is used with the information received from the sensor devices 114 to determine an estimate of the damage for the particular item. In addition, once the estimatics server 100 determines the estimate of the damage, the estimatics server 100 transmits the estimate of the damage to the salvage collection server.

In yet another embodiment, the estimatics server 100 uses the information received from the sensor devices 114 to build a series of multi-viewpoint images representative of the three-dimensional (3-D) item and illustrating the damaged and non-damaged parts. The estimatics server 100 may transmit the series of multi-viewpoint images along with the estimate of the damage, and the information from the sensor devices to the insurance entity 116, the client device 118 and/or the repair entity 120.

Next per step 308, the estimatics server 100 transmits a list of repair entities to a user. In one embodiment, the estimatics server 100 generates the list, via the list generation application 106, as described above. The estimatics server 100 may use the determined geographic location to query one or more of the information sources 122 to determine a plurality of repair entities proximate to the geographic location. In another embodiment, the list is first sent to the insurance entity 116 for approval of the repair entities.

Next per step 310, the estimatics server 100 transmits the estimate of the damage and in some instances the raw data received from the sensor devices 114 to a selected repair entity. The repair entity is selected by a user of the client device 118 such as via a mobile application running thereon. In one embodiment, selection is only enables when a damage claim receives authorization from the insurance entity 116.

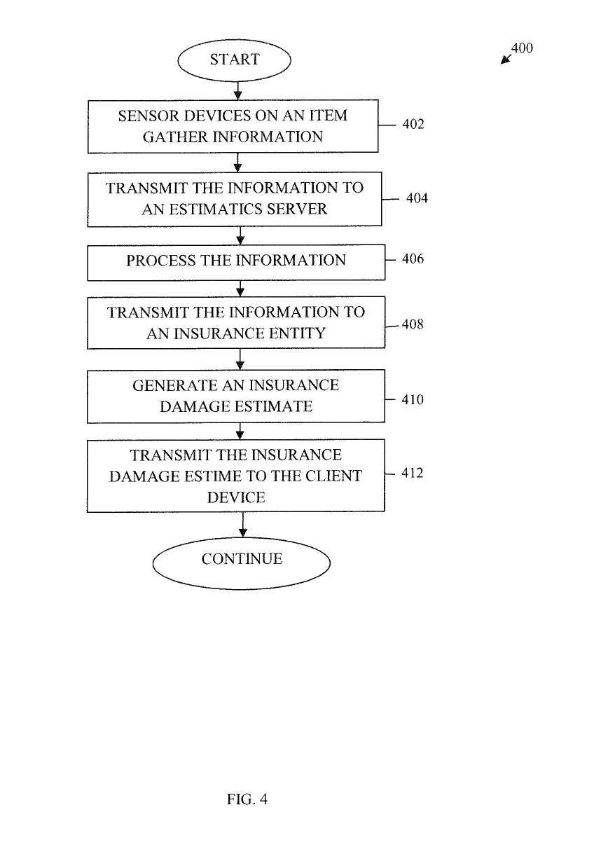

Referring now to FIG. 4, another exemplary embodiment of a method 400 of employing the estimatics server 100 of the present disclosure to efficiently generate an estimate of damage is described. The method 400 comprises at step 402 gathering information relating to an item by the sensor devices 114. The sensor devices 114 are attached to the surface of the exterior and interior elements of the item as described above. The sensor devices 114 gather the information regarding the entirety of the item (i.e., anywhere that a sensor is placed) via live, real-time data communication.

Next, per step 404, the sensor devices 114 transmit the information to the estimatics server 100 when a damage event has occurred. The estimatics server 100 upon receipt of the information processes the information into a useable format (step 406). In one embodiment, the estimatics server 100 processes the information, via the processing application 108 into a format which allows the estimatic server 100 to compare the damaged parts of the item to certain criteria standards. The comparison helps to determine the extent of the damage, whether the item is operational, and/or whether the damage is serious enough in nature to elicit the estimatics server 100 to contact emergency personal and/or a repair entity. In other words, each portion of the item may be given a specific threshold of acceptable damage for which repairs are deemed unnecessary. In one variant, the processing application 108 processes the information into a format, similar to those found in OEM specifications.

Per step 408, the estimatics server 100 transmits the information to the insurance entity 116. The insurance entity 116 upon receipt of the information generates an insurance damage estimate for the item (step 410). The insurance damage estimate may be created by first, comparing the processed information to OEM specifications to determine the extent of the damage, whether the parts are fixable or whether the parts need to be replaced. After the extent of the damage is determined, the insurance entity 116 determines the labor rate prices and application tax rates for the geographical location of the item and/or the user. In one variant, the insurance entity 116 determines whether the item is a total loss. When the insurance entity determines that the item and/or parts are a total loss then the actual cash value of the item and/or parts is determined. Actual cash value of the item is determined, in one embodiment via consultation to third party sources. In another embodiment, the total loss value is determined via consultation to third party sources. The third party sources provide a total loss evaluation, which includes comparable vehicle analysis obtained through current similar items for sale through item information sources 130, such as, autotrader.com, cars.com, National Automobile Database Association (NADA), Kelly Blue Book, etc. Alternatively, the foregoing evaluation may occur at the estimatics server 100. The insurance damage estimate further includes an authorization for the repairs, where warranted.

The insurance entity 116 further determines the amount of the total repairs which the insurance entity is willing to cover; this may include payment in full of the entire repair amount, payment only of an estimated amount, or payment of a portion of the estimated or full repair amount. In one embodiment, the insurance entity 116 determines the coverage based on whether the user was at fault and to what degree as well as on the specific user's coverage policy. In this embodiment, the insurance entity looks at such factors as who was at fault, what caused the accident and/or damage, was there a violation of a law, such as a traffic citation or moving violation, was negligence involved in the damage and/or did everyone involved try to avoid causing the damage. Based on this determination the insurance entity 116 sets the coverage limit. In one variant, the insurance entity 116 also generates a list of repair entities 120, which have been approved by the insurance entity 116 as acceptable repair entities 120. Alternatively, the insurance entity may be provided a list based on nearness to the user, and from this list remove non-approved repair facilities.

In another embodiment, the insurance entity 116 receives the estimate of the damage from the estimatics server 100 and generates its own estimate of the damage based on the estimatics server 100 estimate. In this embodiment, the insurance entity 116 verifies the estimatics server 100 estimate of the damage by comparing the estimate of the damage determined by the estimatics server 100 with its own damage estimate algorithms via utilization of the same raw data and additional information gathered by the estimatics server 100. When the estimates of the damage are consistent, the resulting action is that the insurance entity 116 processes the claim without requiring further inspections or verifications. However, when the estimates of the damage are not consistent then the insurance entity 116 may take further steps to verify the estimate, such as requiring a field inspection of the item or requiring additional verification from other sources, such as police reports and witnesses. Alternatively, one or the other estimate may merely be adopted, or a compromise may be reached.

Next per step 412, the insurance entity 116 transmits the insurance damage estimate to the client device 118. Additionally, or alternatively, the insurance damage estimate may be directed to a selected repair facility 120 and/or the estimatics server 100.

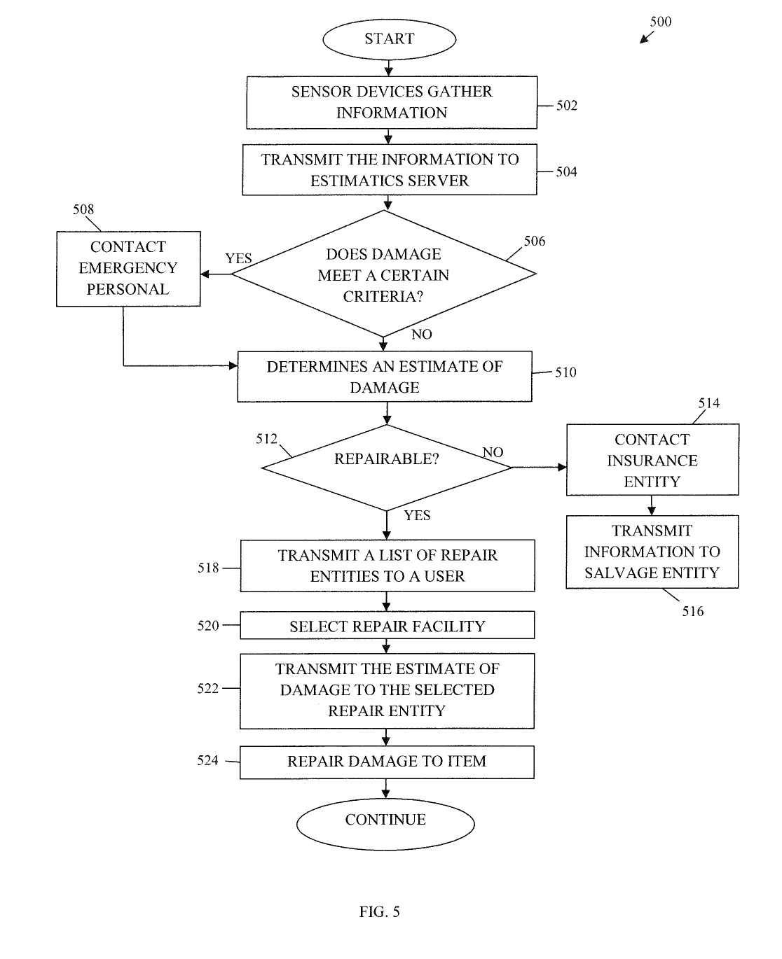

Referring now to FIG. 5, another exemplary embodiment of another exemplary method 500 of employing the estimatics server 100 of the present disclosure is given. As shown, the method 500 efficiently estimates the damage to an item, contacts emergency personal, and to efficiently provides a list of repair entities to a user. Specifically, at step 502 the sensor devices 114 on an item to gather information. The sensor devices 114 are applied to the surfaces of the item as described above (e.g., the surfaces of the external and internal components of the item in some instances). The sensor devices 114 gather the live, real-time data relating to the level and severity of the damage to every part in the item.

Next, per step 504, the sensor devices 114 transmit the information to the estimatics server 100 when a damage event has occurred. The estimatics server 100 upon receipt of the information determines whether the damage meets certain criteria (step 506). In one embodiment, meeting the certain criteria indicates that the item is not usable and/or the damage to the item is serious enough in nature to cause the estimatics server 100 to contact emergency personal (step 508). In one embodiment, the emergency personal may include the police department, the fire department, and/or emergency medical services (e.g., ambulance/paramedic services).

Next per step 510, the estimatics server 100 determines an estimate of the damage to the item. The estimatics server 100 determines the estimate based on the location of each of the sensor devices 114 on the item and a variance thereof with respect to its original position. Additional information gathered from the sensors 114 is also compared to the original equipment manufacturer (OEM) specifications. Next information received from one or more information sources 122 is utilized to further understand the extent of the damage and generate an estimate. In addition, an algorithm based on historical damage analysis of trained physical damage estimators is also used to determine the estimate of the damage.

The estimatics server 100 interprets and autonomously determines which parts of the item must be replaced, which parts are able to be repaired, and which parts are not damaged enough to warrant repair or replacement based on the severity and location of the damage from the information received from the sensor devices 114. In addition, the estimatics server 100 when determining the estimate takes into account the labor rate prices and the tax rates based on the geographic location of the item and/or the user. The geographic location may be determined e.g., based on the information received from the sensor devices 114 and/or by sending a request to the client device 118 inquiring about the item and/or the user's location.

In yet another embodiment, the estimatics server 100 transmits the information to the insurance entity 116 to determine an estimate of the damage (see discussion of FIG. 4 above). Once, the insurance entity 116 has determined the estimate of damage, the insurance entity 116 transmits the estimate of damage to the estimatics server 100.

Next, per decision step 512, the estimatics server 100 determines whether the item is repairable. The determination of whether the item is repairable is based on the estimate of the damage and/or insurance damage estimate. In one variant, the estimatics server 100 determines whether the item is repairable based the information received from the sensor devices 114. In another variant, the estimatics server 100 determines whether the item is repairable based on a combination of the information received from the sensor devices 114 and the determined estimates of damage and/or insurance damage estimate.

When it is determined that the item is not repairable the estimatics server 100 contacts the insurance entity 116 (step 514). This may include e.g., transmission of the information received from the sensor devices 114 and/or the determined estimate of damage 114 as well.

Per step 516, the insurance entity 116 transmits information to a salvage entity. In one embodiment, the insurance entity 116 determines which salvage entity to send the information based on a list of salvage entities within the insurance entity's network. The information transmitted to the salvage entity may include the information gathered by the sensor devices 114, the estimate of damage report, the insurance damage estimate, location of the item and/or the contact information of the user. In one variant, a list of non-damaged parts along with the damaged parts is transmitted to the salvage entities 120 within a predetermined radius soliciting offers to purchase the damaged and non-damaged items.

In one variant procedures for total loss such as those discussed in previously referenced co-owned, co-pending U.S. patent application Ser. No. 14/572,660 entitled “APPARATUS AND METHODS FOR MANAGING DELIVERY OF ITEM INFORMATION AND FACILITATING A SALE OF AN ITEM” are implemented. As discussed therein, the insurance entity 116 sends the estimate of the damage and the information received from the sensor devices 114 to the salvage collection server 100. The salvage collection server formats the information and the estimate of the damages into a report and transmits at least a portion of the report to the participating salvage entities 120. The participating salvage entities 120 pay a subscription fee in one embodiment. The report transmitted to the salvage entities is a summary of the information with an option to purchase a full report. The salvage entities 120 submit bids to the salvage collection server. The bids are received and entered in real time and may include such information as the name of the salvage yard, phone number, contact person's name, alternative methods to contact (e.g., mobile phone or email), and/or location of the yard. At a pre-designated “closing” time for the bidding the insurance entity 116 or the estimatics server 100 reviews the bids and selects the best offer to purchase the item. The insurance entity 116 or the estimatics server 100 may choose the best offer based on the best offer price, past experience with a particular salvage yard, grading of service provided, and other such parameters as best services, vehicle data, distance from the client. The winning salvage entity 120 purchases the item from the insurance entity 116 and/or the user of the item and the salvage entity 120 retrieves the damaged item.

Referring back to FIG. 5, when it is determined that the item is repairable the estimatics server 100 transmits a list of repair entities to the user's client device 118. In one embodiment, the estimatics server 100 generates the list, via the list generation application 106, as described above. In another embodiment, the estimatics server 100 uses the determined geographic location to query one or more of the information sources to determine a plurality of repair entities proximate to the geographic location. The insurance entity 116 may pre-approve the facilities listed prior to sending the list to the client device 118 or may be contacted at a separate time to approve a facility from the list selected by the client device 118.

Next, per step 520, the user selects a repair entity from the list and transmits the selection to the estimatics server 100. Information regarding the user-selected repair entity is transmitted to the insurance entity 116 for record keeping purposes. As noted above, the insurance entity 116 may be required to determine whether the user selected repair entity is within the insurance entity's network (i.e., is authorized) and transmits a confirmation to the estimatics server 100 or directly to the client device 118 of the user. The confirmation may include such information as the user is permitted to use the selected repair entity, or the user is not permitted to use the repair entity and provides a list of approved repair entities or the user is not permitted to use the repair entity and is given notification that if the user does use the selected repair entity that the insurance entity will not cover any of the costs associated with the repairs.

Per step 522, the estimatics server 100 transmits the estimate of the damage and the information received from the sensor devices 114 to the user selected repair entity. The item is then transmitted to the repair entity, via either the repair entity picking up the item or the insurance entity or user arranging with a third party (e.g., towing company) to pick up the item and deliver the item to the repair entity. Once the repair entity 120 receives the item, the item is repaired (step 524).

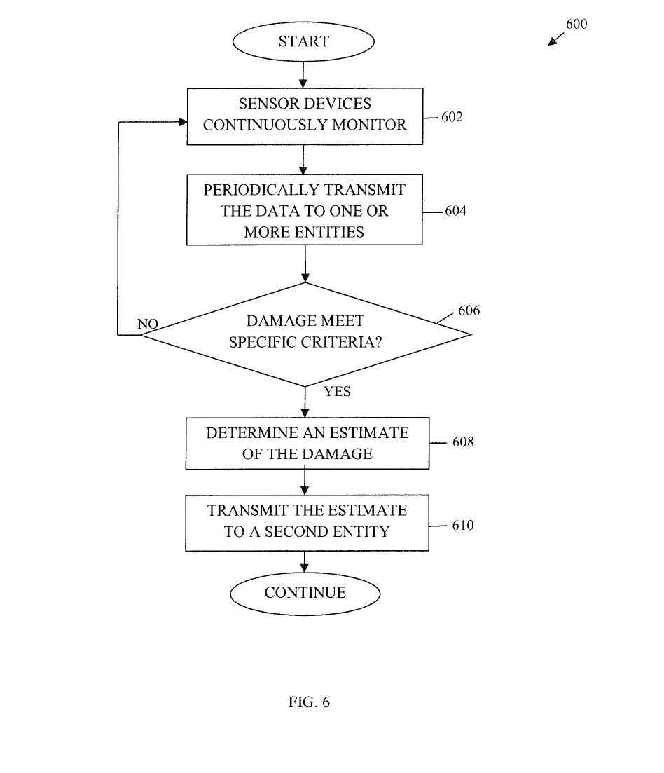

Referring now to FIG. 6, another exemplary embodiment of a method 600 of employing the estimatics server 100 of the present disclosure to efficiently continuously monitor a plurality of items and efficiently estimate the damage to one or more of the plurality of items is described. At step 602, the sensor devices 114 disposed on the surfaces of an item (external and/or internal) continuously monitor the status of the parts of the item on which they are disposed. The sensor devices 114 monitor the condition of the item and all the parts by detecting stress, heat, changed shape, and/or other forms of damage. In one embodiment, the sensor devices 114 measure airflow, GPS positioning, acceleration, temperature, gyroscope readings, strain and magnetic field strength. In addition, the sensor devices not only measure small discrete measurements, but also monitor and records precise patterns of measurements across the item. For example, in the event of a hail storm, the sensor devices 114 monitor the damage from the hail hitting the item (e.g., hitting the roof of a building). In addition, the sensor devices 114 may be configured to alert a user to such environmental conditions.

Next, per step 604, the sensor devices 114 periodically transmit the data to one or more entities. The data transmission may comprise a push or a pull mechanism and occurs irrespective of a damage event. In one embodiment, the data resultant from the continuous monitoring is provided for displayed on the client device 118. The estimatics server 100 receives the periodically transmitted data and processes the data as described above. For example, the estimatics server 100 determines patterns of use, damage over time (as measured by degree of change over time), stress level, and other potentially harmful conditions. The result of continuously monitoring allows the user of the client device 118 and/or the estimatics server 100 to discover faults in the item or parts of the item while they are minor instead of when something breaks. This allows the user of the item to make routine maintenance checks and avoid more costly damage later.

Per decision step 606, the estimatics server 100 determines whether the damage to the item or parts of the item meet a specific criteria. In one embodiment, when the estimatics server determines that the damage does not meet the specific criteria, then the estimatics server 100 continues to monitor the item via the sensor devices 114.

When it is determined that the damage to the item or parts of the item meet the specific criteria (based on the data received), then the estimatics server 100 determines an estimate of the damage (step 608). In one variant, the estimatics server 100 generates an estimate report when the estimatics server 100 has determined the extent of the damage. The estimatics server 100 determines the estimate of the damage as described above. For example, based on roofing and repair standards, when hail impacts exceed specific guidelines, roof repair and/or replacement decisions are expedited in catastrophe situations by the estimate of the damage report. The estimate of the damage eliminates the dangers of adjusters or the user from climbing on the roof and also speeds up the processing of homeowner roof losses. In addition, in determining the estimate of the damage the estimatics server 100 would take into account for the roof example size of the damage, extent of the damage per square foot, damage to the shingles, etc.

Next, per step 610, the estimatics server 100 transmits the estimate of the damage to a second entity. In one embodiment, the second entity is the insurance entity 116, which uses the estimate of the damage to generate an insurance damage estimate for the item and transmits the insurance damage estimate to the user of the item. In one variant, the insurance entity 116 transmits a list of repair entities within the insurance entity's network along with the insurance damage estimate to the user of the item. In another embodiment, the second entity is the user of the item. In this embodiment, the estimatics server 100 transmits the estimate of the damage to the client device 118 of the user. The estimatics server 100 may also transmit a list of repair entities to the client device 118.

### Client Interface/Account Generation and Management—

The features and options discussed above may, in one embodiment, only be made accessible to the users and the insurance entities 116 that have registered and generated an account with the estimatics server 100. Registration and account generation may be coordinated through one or more Internet-based interfaces. Thus, the user and/or the insurance entity 116 may be able to set-up an account with the estimatics server 100 via an Internet connection and a device capable of accessing the Internet (such as a PC, laptop computer, PDA, or other client device).

In order to establish an account (register or set-up), the user and/or the insurance entity 116 will navigate any standard internet browser in order to access a website tied to the estimatics server 100. The website will have at least one tool for demonstrating the capabilities of the estimatics system as well as one tool for enabling clients to “sign up” for estimatics system services.

It is appreciated that a quick description of product and advertising slogans may be displayed on one or more pages of the website. One or more pages of the website may advertise a dedication to quality, and the general purpose of the estimatics system. The estimatics system partners (such as information sources 122 owners) may also be displayed to users and potential users. For example, the website may indicate a partnership with such companies and services as, inter alia, Auto Check, CarFax (for providing vehicle history reports), and Manheim (for providing wholesale pricing information).

Information regarding membership fees, service fees, and subscription levels may also be presented to users via the web interface. A linked email address and/or questions/comments page may also be presented.

The website will present the user and/or the insurance entity 116 with a policy and licensing agreement for use of the protected methods and apparatus of the estimatics system with an option for the user and/or the insurance entity 116 to accept the terms thereof.

Actual registration (set-up) of an account comprises providing the estimatics server 100 with a name, company name and address a phone number associated with the user's client device (for accessing and utilizing the estimatics system) via the web-based interface. Authentication of the device and test messages may be transmitted to ensure system stability. For example, once the user and/or the insurance entity 116 has entered the above information, the user and/or the insurance entity 116 may test functioning of the system by indicating a desire to receive a test message from the estimatics server 100. After the system has been optionally tested, the user and/or the insurance entity 116 provides payment information (including credit card account number, bank information, check card information, check routing number and account, and/or debit card information). The user and/or the insurance entity 116 will be given options to select from subscription plans and/or billing options (such as monthly, weekly, per request, etc.). Authorization of the user is also performed. In one embodiment, this includes determining via information provided by the user that he/she has a current insurance policy in good standing with the insurance entity 116. Additionally, the insurance entity may provide periodic updates to the estimatics server 100 revoking certain user's policies and/or adding additional new members.

Once the payment and other information is received by the estimatics server 100, the user and/or the insurance entity 116 will be associated to an account number and added to a client database associated with the estimatics server 100.

The user and/or the insurance entity 116 will then establish an account password and log-in ID so as to be able to review and edit his account options at the web-based interface (e.g., change payment information, change status of the account, change a subscription level, change a telephone number, and/or change the current password or login ID associated with the user's account, etc.), pay bills, receive email messages, etc. It is appreciated that in the event the user and/or the insurance entity 116 is unable to enter a proper login ID and/or pass word, temporary and/or then-existing passwords and/or ID will be sent to the client device associated with the account via SMS message.

### Business Rules and Considerations—

Various exemplary business-related aspects of present disclosure are now described in detail.

In one embodiment, access to the various ones of the above-described features of the estimatics server 100 is featured as part of one or more optional subscription plans. For example, access to receive periodically transmitted data from the sensor devices 114 may be charged at a premium over more basic services.

In another example, the insurance entity 116 may be offered different reporting levels at different price ranges. It is also appreciated that the aforementioned services may be offered on per transfer of data from the sensor devices with discounts for users reaching a particular threshold number. Alternatively, the insurance entity 116 may purchase a subscription for access to the services on a per-month and/or per-year basis.

In another aspect of the disclosure, the aforementioned processor 102 running on the estimatics server 100 (one or more computer programs located thereon) includes a so-called “rules” engine. These rules may be fully integrated within various entities associated with the present disclosure. In effect, the rules engine comprises a supervisory entity which monitors and selectively controls the item information acquisition and delivery functions at a higher level, so as to implement desired operational or business rules. The rules engine can be considered an overlay of sorts to the remote content management and delivery algorithms.

For example, one rule implemented by the rules engine may comprise accessing only a certain number information sources.

Many other approaches and combinations are envisaged consistent with the disclosure, as will be recognized by those of ordinary skill when provided this disclosure.

It should be recognized that while the foregoing discussion of the various aspects of the disclosure has described specific sequences of steps necessary to perform the methods of the present disclosure, other sequences of steps may be used depending on the particular application. Specifically, additional steps may be added, and other steps deleted as being optional. Furthermore, the order of performance of certain steps may be permuted, and/or performed in parallel with other steps. Hence, the specific methods disclosed herein are merely exemplary of the broader methods of the disclosure.

It will be further appreciated that while certain steps and aspects of the various methods and apparatus described herein may be performed by a human being, the disclosed aspects and individual methods and apparatus are generally computerized/computer-implemented. Computerized apparatus and methods are necessary to fully implement these aspects for any number of reasons including, without limitation, commercial viability, practicality, and even feasibility (i.e., certain steps/processes simply cannot be performed by a human being in any viable fashion).

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The described embodiments are to be considered in all respects only illustrative and not restrictive. The scope of the disclosure is, therefore, indicated by the appended claims rather than the foregoing description. All changes that come within the meaning and range of equivalence of the claims are embraced within their scope.

What is claimed is:

1. An apparatus configured to estimate an extent of damage to at least one item, said apparatus comprising:
a first interface in communication with a plurality of sensor devices located on said at least one item;
a storage apparatus; and
a processor in communication with said storage apparatus and configured to execute at least one computer program thereon, said computer program comprising a plurality of instructions which are configured to when executed by said processor cause said apparatus to:
receive via said first interface a plurality of information from at least one of said plurality of sensor devices, said plurality of information comprising data relating to a current status of said at least one of said plurality of sensor devices; and
evaluate said data relating to said current status of said at least one of said plurality of sensor devices to determine an estimate of damage of said at least one item.

2. The apparatus of claim 1, wherein said plurality of instructions are further configured to, when executed, transmit said estimate of damage to an insurance entity associated with a user of said at least one item.

3. The apparatus of claim 2, wherein said plurality of instructions are further configured to, when executed, receive an authorization from said insurance entity regarding an accuracy to said estimate of damage.

4. The apparatus of claim 3, wherein said plurality of instructions are further configured to, when executed, when said insurance entity declines authorization regarding said accuracy to said estimate of damage, receive an insurance damage estimate to replace said estimate of damage.

5. The apparatus of claim 1, wherein said plurality of instructions are further configured to, when executed, transmit a list of a plurality of repair entities to one or more client devices.

6. The apparatus of claim 5, wherein said list of said plurality of repair entities comprises of repair entities authorized by an insurance entity associated to a user of said at least one item.

7. The apparatus of claim 5, wherein said plurality of instructions are further configured to, when executed, receive a selection of a repair entity.

8. The apparatus of claim 7, wherein said plurality of instructions are further configured to, when executed, transmit said estimate of damage and said plurality of information to said selected repair entity.

9. A method for estimating an extent of damage to at least one item, said method comprising:
receiving a plurality of information from one or more sensor devices located on one or more surfaces of said at least one item, said plurality of information comprising data relating to a damage event;
comparing said plurality of information to item specification information for determining a level of variance therefrom; and
determining a repair estimate based at least in part on said level of variance.

10. The method of claim 9, further comprising transmitting said repair estimate and said level of variance to an insurance entity associated with a user of said at least one item.

11. The method of claim 10, further comprising receiving an authorization from said insurance entity approving said estimate of damage to be transmitted to said user of said at least one item.

12. The method of claim 9, further comprising when said repair estimate is determined; transmitting a list of repair entities to a user, said list of repair entities approved by an insurance entity associated to a user of said at least one item.

13. The method of claim 12, further comprising receiving a selected repair entity from said user via a client device.

14. The method of claim 13, further comprising transmitting said repair estimate to said selected repair entity.

15. The method of claim 9, wherein said item specification information is received from an item information source.

16. A non-transitory computer readable apparatus comprising a storage medium, said storage medium comprising at least one computer program having a plurality of instructions, said plurality of instructions configured to, when executed by a processing apparatus:
receive a plurality of information from at least one of a plurality of sensor devices, said plurality of information comprising data relating to a current status of at least one of said plurality of sensor devices; and
assess said plurality of information data relating to said current status of said at least one of said plurality of sensor devices to determine an estimate of damage of said at least one item.

17. The apparatus of claim 16, wherein said plurality of instructions are further configured to, when executed, receive an item specification information related to said at least one item.

18. The apparatus of claim 17, wherein said assessment further comprises a comparison of said plurality of information to said item specification information in order to determine said estimate of damage.

19. The apparatus of claim 16, wherein said plurality of instructions are further configured to, when executed, transmit a request to a user of said at least one item, said request comprising a confirmation of a user's identity and said at least one item.

20. The apparatus of claim 16, wherein said plurality of instructions are further configured to, when executed, transmit said estimate of repair estimate and said plurality of information to an insurance entity associated with a user of said at least one item.
